(19) United States
(12) Patent Application Publication
(10) Pub. No.: US 2002/0062171 A1
(43) Pub. Date: May 23, 2002

(54) Digital data vending machine

(76) Inventors: Tzu-Feng Tseng, Hsinchu Hsien (TW); Wen-Rei Guo, Chiayi Hsien (TW); Yung-Cheng Hsieh, Kou-Hu Shiang (TW)

Correspondence Address: J.C. PATENTS INC., 4 VENTURE, SUITE 250, IRVINE, CA, 92618, US

(21) Appl. No.: 09/767,394

(22) Filed: Jan. 23, 2001

(30) Foreign Application Priority Data
Nov. 17, 2000 (TW) 89219944

(51) Int. Cl. G06F 17/00

(52) U.S. Cl. 700/231

(57) ABSTRACT

A digital data vending machine suitable for downloading digital data to a user after a payment and allowing a service provider to update digital data at any convenient time. The user uses the input controller to select digital data content. Thereafter, the fee-charging device is activated under the supervision of the central processing unit. The requested digital data are permitted to be transferred from the data storage device to the data input/output device, ready for the user to download when proper fees are paid. The service provider also uses the input controller to select the digital data content to be updated. After selection, external data is transferred from the data input/output device to the data storage device under the supervision of the central processing unit.

### CROSS-REFERENCE TO RELATED APPLICATION

This application claims the priority benefit of Taiwan application serial no. 89219944, filed Nov. 17, 2000.

### BACKGROUND OF THE INVENTION

1. Field of Invention

The present invention relates to a digital data vending machine. More particularly, the present invention relates to a manually controlled digital data vending machine capable of sending the required digital data to a customer on receiving a payment.

2. Description of Related Art

In general, a computer user requiring a piece of software can go to a software shop and ask the salesperson to pick up certain magnetic disks or optical disks in return for a sum of money. Alternatively, a computer user may download the required digital data from a remote terminal through the Internet. FIG. 1 is a conventional system showing the process of downloading digital data from a remote terminal. As shown in FIG. 1, the system includes a server 10, a network 12, a data processor 14, a computer 16 and a broadcasting device 18. The server 10 and the network 12 are generally connected by a dedicated line or a broadband transmission medium 20. A telephone line 22 is often used to connect the network 12 with the data processor 14. Connections between the data processor 14, the computer 16 and the broadcasting device are generally achieved through normal transmission cables 24 and 26.

To get the required digital data, a computer user must provide the computer 16 with a correct network address and contact telephone number. Through the transmission cable 24, dialing information is sent to the data processor 14. The data processor 14 dials up accordingly so that a remote server 10 or an Internet service provider (ISP) is connected. The computer 16 is now able to communicate with the server 10 via internal TCP/IP communication protocol. Through application software, the computer 16 can select the digital information to be transmitted or downloaded. Ultimately, the transmission or downloading is initiated. At this moment, the digital signal processing (DSP) engine of the digital processor 14 converts the signals received from the telephone line 22 into digital data. The converted data is transferred to the computer 16 through the transmission cable 24 and subsequently broadcast by the broadcasting device 18.

The two aforementioned methods for obtaining digital data have their advantages and disadvantages. A user that needs to access different types of digital data will be inconvenienced by the frequent stops at software retailing shops necessary in the first method. However, in this way a user can normally get the data required while the software provider can secure a profit through the business transaction. The second method is very convenient to the user because downloading from the Internet is fast and can save a lot of traveling time. Nonetheless, the software provider of the digital data needs to receive a copyright payment in order to profit. Difficulty in securing the copyright payment renders such a downloading method unprofitable as far as the software providers are concerned.

### SUMMARY OF THE INVENTION

Accordingly, one object of the present invention is to provide a non-local digital data vending machine that can cater to the convenience of users as well as to the profitability of the software providers. In addition, a data-refreshing service can also be maintained by a service provider so that the users can obtain the most up-to-date information.

A second object of the invention is to provide a digital data vending machine that not only can download digital data to the user after a payment, but also can constantly update the digital data through external data transmission.

To achieve these and other advantages and in accordance with the purpose of the invention, as embodied and broadly described herein, the invention provides a digital data vending machine. The vending machine includes a main board, a central processor, an input controller, a data input/output device, a fee-charging device and a data storage device. The central processor is connected to the main board for controlling the downloading of digital data and performing digital data updating. The input controller is connected to the main board for providing the user and any updating personnel with the required operations, as well as displaying the content of digital data and the transaction processes. The data input/output device is connected to the main board for carrying out either digital data downloading or digital data updating. The fee payment device is connected to the main board for receiving the user's payment. The data storage device is connected to the main board for holding the digital data to be vended.

During operation, the user uses the input controller to request the type of digital data. Under the supervision of the central processor, data is downloaded from the data storage device to the data input/output device after the fee-charging device is activated. Data can also be refreshed by operating the input controller to select the content of the digital data to be updated and then inputting external data into the data storage device via the data input/output device.

This invention may further include a loudspeaker that connects with the main board for guiding the data downloading process vocally. The input controller can be a touch control display or a user input device together with a display monitor. The user input device can be a keyboard, a mouse or a tracker ball, for example. The digital data can be music, game programs, image patterns, or document data, for example. The data input/output device can be a memory card, personal digital assistant, a mobile telephone or a CD-RW, for example. In addition, the fee-charging device can be a note/coin receiver, a credit card reader or stored value card reader, for example. Furthermore, the data storage device can be a hard disk or other random access memory, for example.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a conventional system showing the process of downloading digital data from a remote terminal;

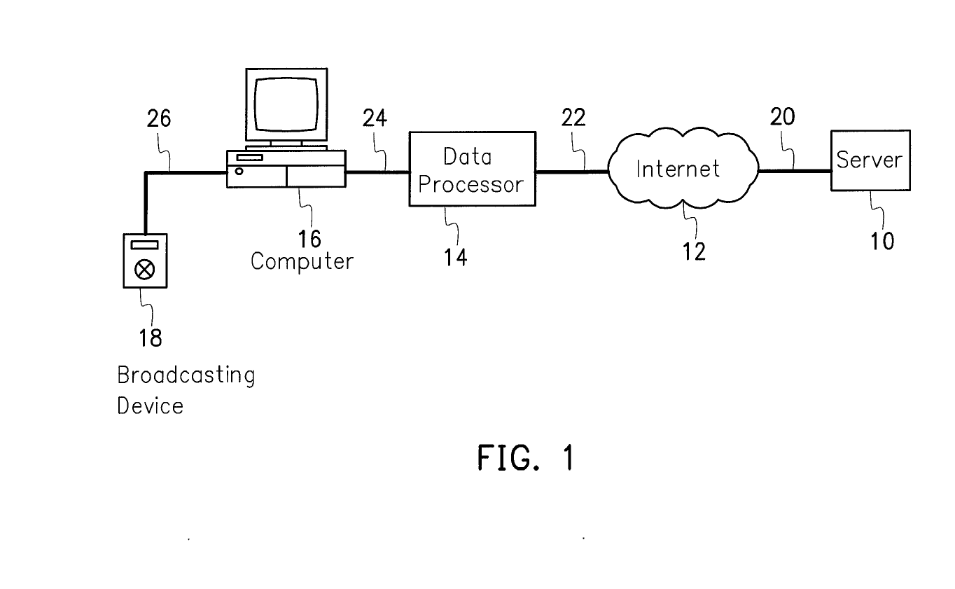

FIG. 2 is a digital data vending machine system according to one preferred embodiment of this invention;

FIG. 3 is a flow chart showing the steps for operating the digital data vending system according to this invention; and

FIG. 4 is a flow chart showing the series of steps for a digital data provider to update information by sending in external data.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

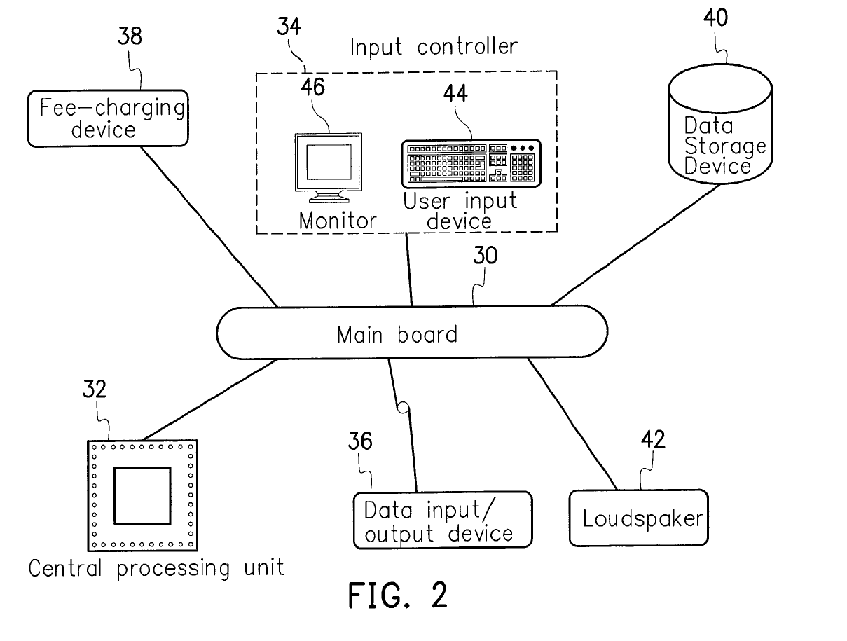

FIG. 2 is a digital data vending machine system according to one preferred embodiment of this invention.

As shown in FIG. 2, the digital data vending system includes a main board 30, a central processor 32, an input controller 34, a data input/output device 36, a fee-charging device 38 and a data storage device 40. The system further includes a loudspeaker 42 and the input controller 34 actually includes a user input device 44 and a monitor 46. The central processor 32, the data input/output device 36, the fee-charging device 38, the data storage device 40, the loudspeaker 42, the user input device 44 and the monitor 46 are all connected to the main board 30 so that the main board 30 can receive and output signals to various devices.

The digital data vending machine is able to receive payment before downloading digital data to users. Detailed operation of the machine is described as follows. First, the user can select the type of digital data to be downloaded via the input controller 34. The input controller 34 can be a touch control display or can be a system that includes a user input device 44 and a monitor 46. The user input device 44 can be a keyboard, a mouse or a tracker ball, for example. The user input device 44 facilitates the user in the selection of the type of digital content to be downloaded, for example, music, video games, image patterns, document data and so on. Through the supervision of the central processor 32, payment is checked by probing registers such as a note/coin cashier, a credit card reader or a stored value card reader. The fee-charging device will be triggered only when a correct payment is submitted. Thereafter, the requested data is sent from the data storage device 40, which can be a hard drive or a random access memory, to the data input/output device 36 of the user. The data input/output device 36 can be a memory card, a personal digital assistant, a palmtop device or a CD-RW, for example. The data input/output device 36 and the main board 30 are connected through an interface card (not shown). The interface standard used by the interface card can be IDE, SCSI, USB or IEEE 1394, for example. Furthermore, the system may use the loudspeaker 42 to guide user in the downloading process vocally.

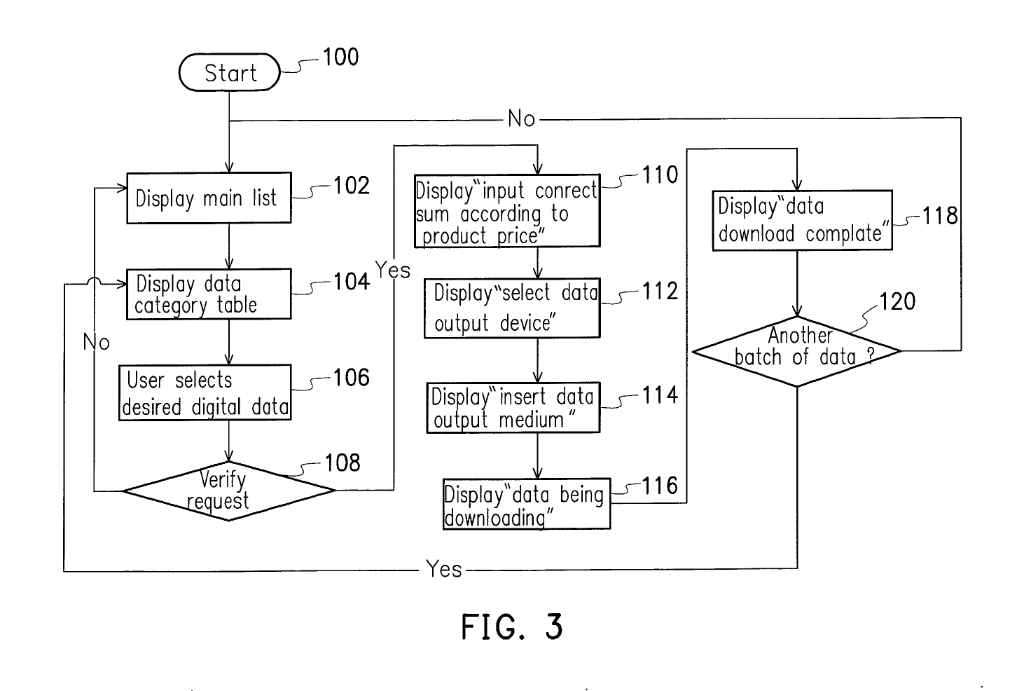

To explain the operation of the digital data vending machine more fully, a flow chart is drawn in FIG. 3 showing the steps involved in operating the system. In step 100, a user initiates the operation. In step 102, a list of selectable items is shown on a display screen or monitor. The list may include major data categories such as music, game programs, image patterns or text documents. The user is free to request any item via the user input device. After initial selection of the categories, a finer subdivision of the type of digital content is listed in step 104. The user makes one further selection from the list in step 106 to pinpoint the exact product requested. After careful inspection of the product, the user decides to purchase the digital product or not. If the user refuses to accept the product, control is returned to step 102 so that the user may select again from the main list. On the other hand, if the user still wants the product, control is branched to step 110. In step 110, the user is prompted by the monitor to input the correct amount of payment according to the labeled product price. At this point, the device in this invention will check to see if the user has sent out any payment by probing connected teller devices such as note/coin cashier, credit card reader or stored value card reader. After payment is verified, step 112 is executed, informing the user, with a prompt, to select the data output device. In step 114, the display will issue a message asking the user to insert a data output medium. At this point, the user must properly mount a device such as a memory card, a personal digital assistant, a palmtop device or CD-RW in the data input/output device. In step 116, a message will appear on the display screen informing the user that the system is downloading the required data. Meanwhile, the required data is downloaded from the data storage device to the data input/output device of the user. On completion of downloading, a message saying download completion will appear on the display screen in step 118. In step 120, the user is asked if any more data downloading is required. If the user decides to download similar data, control jumps to step 104 so that the user may select other items from the list. Otherwise, control is returned to step 102 and the selection process is started anew.

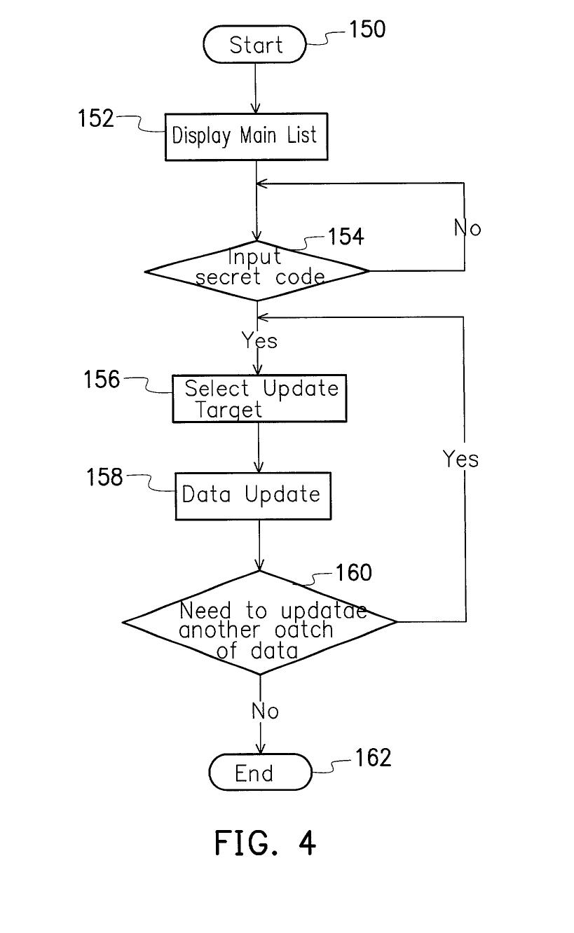

FIG. 4 is a flow chart showing the series of steps for a digital data provider to update information by sending in external data. As shown in FIGS. 2 and 4, a digital data provider initiates the updating operation in step 150 through the input controller 34. In step 152, a main list of possible selections will appear on the display screen. In step 154, a code is input to determine the identity of the updating person. On agreeing to a modification, the updating person is permitted to select the refreshing target (digital data content to be updated) in step 156. Under the supervision of the central processing unit 32 in FIG. 2, data is updated in step 158. As shown in FIG. 2, external data is transferred to the data storage device 40 from the data input/output device 36. On completion of data update, the system inquires in step 160 to determine if there is a need to update another batch of data. Control is returned to step 156 if more data updating is needed, otherwise, step 162 is executed to exit the current updating program.

In conclusion, this invention facilitates the downloading of digital data by a user, using a non-local digital data vending machine with a payment checking device, so that a digital data provider can secure a profit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital data vending machine suitable for downloading digital data to a user after a payment and allowing a service provider to update digital data at any convenient time, comprising:
a main board;
a central processing unit connected to the main board for overseeing the downloading and the updating of digital data;
an input controller connected to the main board for displaying the content of digital data as well as any intermediate operating steps so that users or data updating personnel are informed all the time;
a data input/output device connected to the main board for performing digital data downloading or updating;
a fee-charging device connected to the main board for receiving payment from the user; and
a data storage device connected to the main board for holding digital data;
wherein the user uses the input controller to select digital data content, thereafter, the fee-charging device is activated under the supervision of the central processing unit, and the requested digital data are permitted to be transferred from the data storage device to the data input/output device, ready for the user to download when fees are paid; and the service provider also uses the input controller to select the digital data content to be updated, and external data is transferred from the data input/output device to the data storage device under the supervision of the central processing unit.

2. The data vending machine of claim 1, wherein the machine further includes a loudspeaker connected to the main board for guiding the user in the downloading process vocally.

3. The data vending machine of claim 1, wherein the input controller includes a touch control display.

4. The data vending machine of claim 1, wherein the input controller comprises of a user input device and a display monitor.

5. The data vending machine of claim 4, wherein the user input device includes a keyboard.

6. The data vending machine of claim 4, wherein the user input device includes a mouse.

7. The data vending machine of claim 4, wherein the user input device includes a tracker ball.

8. The data vending machine of claim 1, wherein the digital data includes musical data.

9. The data vending machine of claim 1, wherein the digital data includes game programs.

10. The data vending machine of claim 1, wherein the digital data includes image patterns.

11. The data vending machine of claim 1, wherein the digital data includes text documents.

12. The data vending machine of claim 1, wherein the data input/output device includes a memory card.

13. The data vending machine of claim 1, wherein the data input/output device includes a personal digital assistant.

14. The data vending machine of claim 1, wherein the data input/output device includes a palmtop device.

15. The data vending machine of claim 1, wherein the data input/output device includes a CD-RW.

16. The data vending machine of claim 1, wherein the fee-charging device includes a note/coin cashier.

17. The data vending machine of claim 1, wherein the fee-charging device includes a credit card reader.

18. The data vending machine of claim 1, wherein the fee-charging device includes a stored value card reader.

19. The data vending machine of claim 1, wherein the data storage device includes a hard drive.

20. The data vending machine of claim 1, wherein the data storage device includes a random access memory device.
